(19) United States
(12) Patent Application Publication
(10) Pub. No.: US 2011/0255737 A1
(43) Pub. Date: Oct. 20, 2011

(54) System for determining sorting information for mail

(75) Inventors: Christine Gotz, Mering (DE); Sebastian Kittel, Darmstadt (DE); Torsten Plankert, Kurten (DE)

(73) Assignee: Deutsche Post AG, Bonn (DE)

(21) Appl. No.: 13/140,993

(22) PCT Filed: Nov. 23, 2009
(86) PCT No.: PCT/EP2009/008310

§ 371 Date: Jun. 20, 2011

(30) Foreign Application Priority Data
Dec. 22, 2008 (DE) 10 2008 064 033.6

(51) Int. Cl. G06K 9/00

(52) U.S. Cl. 382/101

(57) ABSTRACT

There is provided a system for determining sorting information for a mailpiece. An exemplary system comprises a control unit that is located in a first mail center. The control unit is configured to send reading requests based on received mailpiece images to a reading unit in which the sorting information can be determined The control unit comprises a first standard interface for feeding mailpiece images. The system also comprises a transmission unit that is configured to receive a mailpiece image of the mailpiece in a second mail center and to transfer the mailpiece image to the control unit via the first standard interface. The control unit generates a reading request for the reading unit pertaining to the mailpiece image.

### CROSS-REFERENCE TO RELATED APPLICATIONS

Pursuant to 35 U.S.C. §371, this application is the United States National Stage Application of International Patent Application No. PCT/EP2009/008310, filed on Nov. 23, 2009, the contents of which are incorporated by reference as if set forth in their entirety herein, which claims priority to German (DE) Patent Application No. 10 2008 064 033.6, filed Dec. 22, 2008, the contents of which are incorporated by reference as if set forth in their entirety herein.

### BACKGROUND

For purposes of conveying mailpieces to their destination addresses, the mailpieces are normally collected in the outgoing region in a mail distribution center and, within the scope of so-called outgoing sorting, they are associated with the mail distribution center of the destination region. In the destination region, the mailpieces are then forwarded from the appertaining mail distribution center to the mail carrier responsible for the delivery. In this context, the sorting of the mailpiece is highly automated and comprises the use of several devices for sorting the mailpieces and for acquiring the recipient addresses used for the sorting.

Sorting machines that have a scanner device for acquiring mailpiece images are normally used for sorting the mailpieces. On the basis of the mailpiece images, reading units are used to determine mailing data such as especially the recipient address or the components of the recipient address that are relevant for the sorting. The reading units employed are usually automatic address readers that automatically determine the recipient address by means of an OCR method (OCR: Optical Character Recognition). Moreover, there is usually a video encoding system comprising several video encoding stations where the address is determined by video encoding operators whenever it could not be read automatically. The sorting machines and reading units that are operated in a mail distribution center are normally associated with a central control component that controls the address encoding. The control component receives mailpiece images from the sorting machines and, on the basis of prescribed encoding rules, it generates reading requests for the reading units that are present. The control component reports the reading results that are determined in the reading units back to the sorting machine in question, which then sorts the mailpiece in question on the basis of the reading results.

A difficulty often lies in the planning for the reading units needed for processing the mailpieces, since as a rule, the mail volume to be processed is not precisely known. Moreover, mailpieces are not dropped off continuously at a mail distribution center, so there are constantly fluctuations in the required processing capacity. Consequently, a mail distribution center always has to have enough reading units available to process the maximum mail volume that needs to be processed so that, even if the mail volume is especially high, a sufficient processing capacity will be available. However, it is financially disadvantageous to have to keep the maximally needed processing capacity available within the mail distribution center since it only rarely has to be used. This applies especially to the video encoding system since, on the one hand, its operation involves a great deal of resources and, on the other hand, only very imprecise predictions can be made about the mail volume that will have to be processed, since this fluctuates not only with the mail volume in the mail distribution center, but also with the reading rate of the automatic address readers.

For example, in this context, EP 1 733 809 B1 has already proposed shifting especially the video encoding away from one mail distribution center to another mail distribution center or to a video encoding center. In this manner, the video encoding of several mail distribution centers can be combined, thereby allowing more efficient operations planning for the video encoding system. In order to establish communication among multiple locations, EP 1 733 809 B1 proposes that the processing units such as sorting devices and reading units of several locations be networked directly with each other. However, this is hardly or not at all possible when the above-mentioned central control component is used for controlling the encoding process.

### SUMMARY

The subject innovation relates to the determination of sorting information for mailpieces. In particular, the subject innovation relates to systems for determining sorting information for a mailpiece.

An embodiment of the subject innovation makes it easier to shift reading functions from one mail distribution center to another mail center. In particular, the existing infrastructure should only have to be modified as little as possible.

According to the subject innovation, a system for determining sorting information for a mailpiece is suggested. The system comprises a control unit that is located in a first mail center and that is configured to send reading requests based on received mailpiece images to a reading unit in which the sorting information can be determined, the control unit comprising a first standard interface for feeding mailpiece images. Moreover, a transmission unit is provided that is configured to receive a mailpiece image of the mailpiece in a second mail center and to transfer the mailpiece image to the control unit via the first standard interface, so that the control unit can generate a reading request for the reading unit pertaining to the mailpiece image.

According to the subject innovation, a reading unit of a first mail center is used to process mailpiece images that are acquired in a second mail center. The reading unit of the first mail center is connected to a control unit of the first mail center, which also provides a standard interface for feeding the mailpiece images. In the proposed system, this standard interface is used by a transmission unit in order to transfer a mailpiece image acquired in the second mail center to the control unit of the first mail center. Thus, an existing standard interface can be used to transfer mailpiece images, so that there is no need for a complex modification in the first mail distribution center, especially a complex modification of the control unit of the first mail center.

A standard interface within the scope of the subject innovation refers particularly to an interface of a control unit that is normally provided by the control unit of a mail distribution center, especially irrespective of whether the mail distribution center processes mailpiece images that are acquired locally or mailpiece images that are acquired in another mail center. In a system according to the subject innovation, such an interface can be used to transfer mailpiece images from the transmission unit to the control unit. This means that no special interface has to be provided for the connection of the transmission unit.

In one embodiment of the system, the control unit is configured to output reading results that are determined in the reading unit via the first standard interface, and the transmission unit is configured to receive a reading result pertaining to the mailpiece image via the first standard interface and to transmit the received reading result to the second mail center. Advantageously, in this embodiment, the transmission unit uses the first standard interface to receive the reading result that was determined in the first mail distribution center on the basis of the reading request pertaining to the mailpiece image.

Another embodiment of the system provides that the first standard interface corresponds to a standard interface between the control unit and a sorting machine that comprises an image-acquisition unit for acquiring mailpiece images and that is configured to sort mailpieces based on reading results. The standard interface for connecting a sorting machine to the control unit advantageously provides the functionalities that the transmission unit uses in order to transfer the mailpiece images to the control unit and in order to receive the determined reading results pertaining to the mailpiece images from the control unit.

One embodiment of the system comprises that the first mail center has at least one sorting machine that communicates with the control unit via another first standard interface. In this embodiment, the first mail center is a mail distribution center in which mailpieces are sorted sorting machines. Here, the subject innovation makes it possible for the reading units of the mail distribution center to be concurrently used by another mail distribution center.

In another embodiment, however, the first mail center can also be an encoding center where only one or more reading units are operated, but where no mailpieces are sorted.

One embodiment of the system according to the subject innovation is characterized in that the first and/or the second mail distribution center has several reading units of different types that consecutively receive reading requests and that determine reading results pertaining to the mailpiece image. These reading units can be, for example, automatic address readers as well as a video encoding system in which mailpiece images are processed whenever an address was not or not completely recognized in the automatic address readers.

In an exemplary system, it may be provided that the reading units are located in the first mail center. The second mail center does not have its own reading units, so that all of the reading functions are shifted elsewhere.

Another embodiment of the system provides that the second mail center comprises at least one reading unit of a first type, and the mailpiece image can be transmitted by means of the transmission unit to the first mail center in order to determine a reading result in a reading unit of a second type if the reading unit of the first type was not able to recognize a predetermined mailpiece feature on the basis of the mailpiece image. In this embodiment, only a specific reading function is shifted from the second mail center to the first mail center. The mailpiece feature can be, for example, a predetermined component of a recipient address of the mailpiece that is relevant for the sorting of the mailpiece in the second mail center. If outgoing sorting, for example, is carried out in the second mail center, then the mailpiece feature can particularly be a postal code contained in the recipient address of the mailpiece.

In another embodiment, it is provided that the reading unit of the first type is an automatic address reader for reading a recipient address on the basis of the mailpiece image. Yet another related embodiment of the system comprises that the reading unit of the second type is a video encoding system.

It is advantageous if a reading result that was determined in the second mail center is taken into consideration in the first mail center, so that reading functions do not have to be carried out multiple times. If, for example, an address component was not recognized by an automatic address reader in the second mail center, then it is an advantageous approach to not once again feed the mailpiece image to an automatic address reader in the first mail distribution center.

Therefore, one embodiment of the system is characterized in that the control unit is configured to generate the reading request based on available reading results pertaining to the mailpiece image according to encoding rules, and the transmission unit is configured to transfer, in addition to the mailpiece image, a reading result that was determined in the second mail center based on the mailpiece image in the first reading unit to the control unit via the first standard interface. The use of configurable encoding rules is normally likewise a standard functionality of the control unit of a mail center.

In another embodiment of the system, the control unit is configured to generate a reading request for the reading unit of the second type pertaining to mailpiece images that are transferred by the transmission unit. Such a configuration of the control unit can be prescribed, for example, on the basis of the encoding rules. Thus, in a simple manner, it is possible to configure the control unit in such a way that, when a mailpiece image is transferred by the transmission unit, a reading request is always generated for a reading unit of a specific type.

According to an aspect of the subject innovation, a further system is provided for determining sorting information for a mailpiece. The system comprises a control unit of a second mail center, the control unit being configured to generate a reading request on the basis of a mailpiece image acquired in the second mail center and to supply the mailpiece image to a reading unit via a standard interface. Moreover, a transmission unit is provided that can be connected to the control unit via the standard interface and that is configured to receive the mailpiece image via the second standard interface and to transmit the received mailpiece image to a first mail center.

In an analogous manner to the above-mentioned transfer of mailpiece images from the transmission unit to the control unit of the first mail center, it is advantageously provided in this system that the transmission unit receives mailpiece images in the second mail center likewise via a standard interface of the control unit of the second mail center. In this case, the additional system can be connected to the system described above.

In one embodiment of the further system, it is provided that the control unit of the second mail distribution center is configured so that, after a reading result that was determined in the first mail center pertaining to the mailpiece image has been transmitted to the second mail center via the standard interface, this reading result is transferred to the control unit of the second mail center. Advantageously, in this embodiment, the standard interface of the control unit of the second mail center can also be used to transfer reading results to the control unit that were determined in the first mail center.

In one embodiment, the second mail center is a mail distribution center where the mailpiece is sorted. Therefore, the control unit of the second mail center is preferably configured to receive the mailpiece image from a sorting machine located in the second mail center and to return the reading result to the sorting machine.

In another embodiment, the standard interface of the control unit of the second mail distribution center corresponds to a standard interface between the control unit and a reading unit. Such a standard interface especially provides functionalities that can be used to transfer mailpiece images from the control unit to the transmission unit and in order to report reading results back to the control unit.

### BRIEF DESCRIPTION OF THE DRAWING

The above-mentioned and additional advantages, special features and advantageous refinements of the invention are also illustrated on the basis of the embodiments that are described below with reference to the figure.

The figure shows:

FIG. 1 is a block diagram showing two mail distribution centers that are connected to each other, only one of which has a video encoding system.

### DESCRIPTION OF SPECIFIC EMBODIMENTS

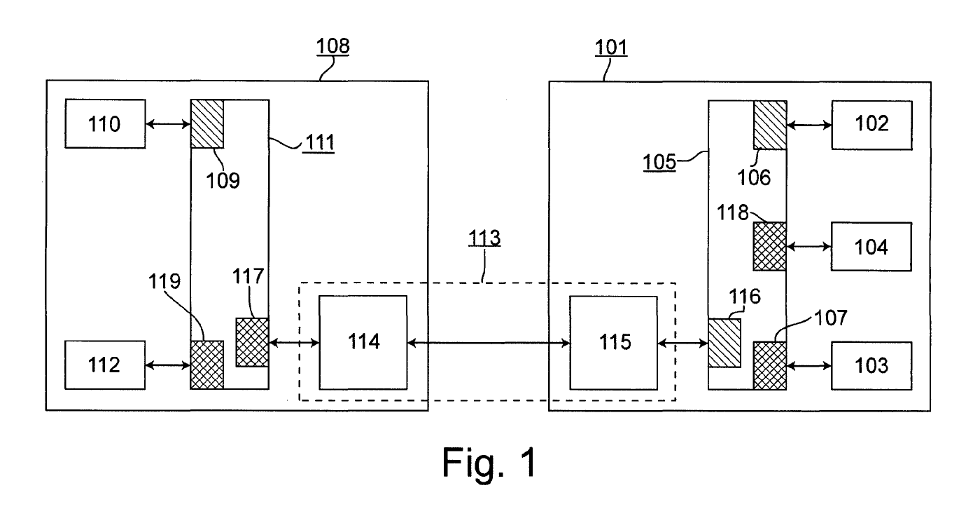

FIG. 1 shows a schematic depiction of selected components of a mail distribution center 101. In the mail distribution center 101, in particular, outgoing sorting of mailpieces is carried out. In this context, mailpieces that were mailed in a geographic region associated with the mail distribution center 101 are associated with intended destinations in the destination regions of the mailpieces. A relevant destination of a mailpiece that is relevant for the outgoing sorting can be, for example, a mail distribution center associated with the destination region where the mailpiece is forwarded to the intended destination within the scope of so-called incoming sorting. In the case of a further-reaching sorting procedure, the destination of the mailpiece can also be a delivery drop-off point associated with the destination where a mail carrier picks up the mailpiece in order to deliver it to its destination.

The outgoing sorting is carried out on the basis of a component of the recipient address of a mailpiece. In one embodiment, the recipient address comprises the name of the recipient, the street and house number, the city and a postal code. The postal codes are unambiguously associated with given street sections and they allow the determination of the delivery drop-off point that is associated with the street section and the mail distribution center that is associated with the specific geographical region where the street section and/or the delivery drop-off point are located. Therefore, in one embodiment, the postal code is used for the outgoing sorting, and consequently, this postal code has to be determined in order to carry out the outgoing sorting. In other embodiments, especially in the case of a different structure of the recipient address, however, other address components can fundamentally also be used for the outgoing sorting.

In the mail distribution center 101, the mailpieces are sorted by the sorting machine 102, one of which is depicted in FIG. 1 by way of an example. As a rule, however, a mail distribution center 101 has multiple sorting machines 102. Here, one or more sorting machines can be provided for sorting mailpieces having different formats. The sorting machines 102 are configured in a manner generally known to the person skilled in the art. They have an entry station where mailpieces are fed into the sorting machine manually or automatically. Moreover, a scanner unit is provided that acquires mailpiece images of the mailpieces, and these images especially contain the recipient addresses. Once the mailpiece images have been acquired in the scanner unit, the mailpieces go to a delay line that retains the mailpieces for a limited period of time of, for example, three to ten seconds. While the mailpieces are in the buffering line, the components of the recipient addresses of the mailpieces that are relevant for the outgoing sorting, that is to say, the postal codes, are acquired, and the corresponding sorting destinations are determined. Furthermore, additional mailing data can be determined that is used for the incoming sorting of the mailpieces in the mail distribution centers of the destination regions. These can be the complete recipient address as well as additional mailpiece features. Corresponding to the determined sorting destinations, the mailpieces are then ejected at a final station of the sorting machine 102. Each sorting machine 102 has a plurality of final stations, each of which is associated with a prescribed sorting destination.

Insofar as mailing data is acquired that is used for carrying out the incoming sorting, in one embodiment, it is provided that the mailing data is applied in machine-readable form, for example, as a barcode, onto the mailpieces before they are ejected at the final stations of the sorting machines 102. During the incoming sorting, the data is acquired and used for sorting the mailpieces. In another embodiment, it is provided that a mailing data record is associated with the mailpieces, and this mailing data record is transmitted from the mail distribution center 101 to the mail distribution center where the incoming sorting is carried out. The association is performed using an identification code that is applied onto the mailpiece and incorporated into the mailing data record. During the incoming sorting, the identification code is acquired in order to determine the mailing data record associated with a mailpiece and in order to carry out the sorting on the basis of the mailing data contained in the mailing data record.

In order to acquire the postal code and, if applicable, additional mailing data, the sorting machine 102 itself can already have a reading unit, which is referred to below as the primary reader. Insofar as a primary reader is present in a sorting machine 102, the primary reader is the first reading unit in which an acquired mailpiece image is processed. Here, the primary reader is configured to recognize recipient addresses within the mailpiece images. The reading rate of the primary reader, however, is relatively slow.

If the recipient address could not be completely acquired in the primary reader, then the mailpiece images are processed in additional reading units 103, 104 of the mail distribution center 101. In one embodiment, there are several automatic address readers 103, one of which is depicted in FIG. 1 by way of an example. In the automatic address readers 103, the recipient address can be acquired on the basis of the mailpiece image of a mailpiece. For this purpose, an automatic address reader 103 has an OCR unit (OCR: Optical Character Recognition) of a type generally known to the person skilled in the art. Moreover, additional automatic reading units can be provided (not shown in the figure) that determine, for example, the sender address and/or additional mailing data. Each reading function is preferably associated with a given type of reader, and one or more automatic reading units of each type are provided in the mail distribution center 101.

Another reading unit of the mail distribution center 101 is a video encoding system 104 to which the mailpiece images are fed whenever the automatic address reader 103 in question could not recognize the postal code of a recipient address that is relevant for the outgoing sorting. Each video encoding station has a display device on which mailpiece images can be displayed in order to show them to a video encoding operator. The video encoding operator determines the postal codes from the mailpiece images and enters them as a reading result into the video encoding system 104 via an input device that is configured, for instance, as a keyboard.

The reading units 103, 104 as well as the sorting machines 102 that are present in the mail distribution center 101 are connected to a central control unit 105 that controls the encoding process, that is to say, the determination of mailing data. For this purpose, encoding rules are stored in the control unit 105 to specify the conditions under which mailpiece images that have been acquired by a sorting machine 102 are processed in the available reading units 103, 104. The encoding rules can provide, for example, that a mailpiece image first has to be processed in an automatic address reader 103 in order to determine the recipient address. If the automatic address reader 103 does not determine at least the postal code contained in the recipient address, then further processing of that particular mailpiece image is carried out in the video encoding system 104 in order to determine the postal code so that the outgoing sorting can be carried out. The encoding rules can be prescribed machine-independently so that the mailpiece images can be processed irrespective of the sorting machine 102 in which that particular mailpiece is being sorted. Furthermore, machine-specific encoding rules can be prescribed, i.e. encoding rules that apply only to mailpiece images that have been acquired in specific sorting machines 102.

The sorting machines 102 present in the mail distribution center 101 are registered in the control unit 105 and are each connected to the control unit 105 via a machine interface 106. Mailpiece images acquired in the sorting machines 102 are transferred to the control unit 105 via the machine interface 106. This is preferably done together with identifications that are associated with the mailpieces in the sorting machine 102 and that allow an association between mailpiece images and mailpieces; and together with an identifier assigned to the sorting machine 102, this identifier making it possible to return reading results to the relevant sorting machine 102. Preferably, the sorting machines 102 each generate a mailing data record containing the acquired mailpiece image as well as the identification and the machine identifier, and the mailing data record is sent to the control unit 105 via the machine interface 106. As an alternative, however, it can also be provided for mailpiece images and identifications to be transferred via the machine interface 106 and for the appertaining mailing data records to be generated in the control unit 105. If a primary reader is present, then the reading results of the primary reader are already incorporated into the mailing data record that was generated in the sorting machine 102 or—if the mailing data record is generated in the control unit 105—the reading results are transferred together with the mailpiece image. The mailpiece images or mailing data records are preferably only transferred from the sorting machine 102 to the control unit 105 when the primary reader has not carried out all of the intended reading functions successfully, that is to say, particularly if the primary reader could not completely determine the recipient address.

In the received or generated mailing data record, the control unit 105 augments the reading results that pertain to the mailing data and that were determined in the reading units 103, 104. After a predetermined processing period, which starts with the receipt of a mailpiece image in the control unit 105, the control unit 105 reports the determined reading results via the machine interface 106 to the sorting machine 102 from which the mailpiece image was received. This sorting machine 102 is identified on the basis of the machine identifier contained in the mailing data record. In this context, it is preferably not the complete mailing data record containing the mailpiece image that is returned to the sorting machine 102 but rather only the determined reading results. In this manner, the data volume to be transmitted is reduced. Likewise, the unambiguous identification is returned, together with the reading results, by the control unit 105 to the relevant sorting machine 102, so that the sorting machine 102 can associate the reading results on the basis of the identification of a mailpiece located in the sorting machine 102. The predetermined processing period is preferably adapted to the period of time during which the mailpiece is held in the delay line of the sorting machine 102. In particular, the processing period is selected so as to be sufficiently smaller than the holding time of the mailpiece in the delay lines so that the reading results needed for the sorting are made available in time in the sorting machines 102.

The automatic address readers 103 are each connected to the control unit 105 via a reader interface 107. Via the reader interface 107, the control unit 105 transmits reading requests to the automatic address reader 103. After a reading request has been received from the control unit 105, the automatic address readers 103 can access the mailing data record to which the reading request applies via the reader interface 107. In particular, the automatic address readers 103 can read out the mailpiece image from the mailing data record and can feed it to the available OCR device. The automatic address readers 103 likewise return to the control unit 105 the reading results that were determined on the basis of a reading request.

The video encoding system 104 is connected to the control unit 105 via an interface 118. This can be a reader interface. Likewise, however, another interface can also be provided between the control unit 105 and the video encoding system 104, which makes it possible to transmit reading requests together with mailpiece images to the video encoding system 104 and to receive reading results from the video encoding system 104.

The reading requests and the reading results reported back from the reading units 103, 104 preferably contain the unambiguous identification of the mailing data record so that these reading results can be associated with the mailing data record.

A first reading request is generated by the control unit 105 when a mailing data record has been transmitted with a mailpiece image from a sorting machine 102. Moreover, according to the prescribed encoding rules, another reading request can be generated when a reading result is obtained from a reading unit 103, 104 that is to be improved in that the mailpiece image is processed in another reading unit 103, 104. In this case, in one embodiment, the reading requests are each generated as a function of the current content of the mailing data record, particularly of the received reading results. In addition to this, however, on the basis of applicable encoding rules, it can also be taken into account which units have supplied a result. Thus, for example, a reading request can be generated as a function of the sorting machine 102 that provided a mailpiece image.

When the encoding rules explained above by way of example are used, the control unit 105 generates a first reading request when it receives a mailing data record from a sorting machine 102. Then the first reading request is transmitted to an automatic address reader 103. In one embodiment, this is done because the control unit 105 ascertains that the mailing data record does not yet contain a reading result or at least a negative reading result of the primary reader. In another embodiment, the reading request for the automatic address reader 104 can also be generated because the control unit 105 ascertains that a new mailing data record or a new mailpiece image has been supplied by a sorting machine 102. The reading result determined by the automatic address reader 103 during the processing of the reading request is then incorporated into the mailing data record via the control unit 105.

Then the control unit 105 checks whether the mailing data record contains the postal code of the recipient address or whether a negative reading result pertaining to the postal code was returned from the automatic address reader 103. If the postal code is present, the reading results are returned to the sorting machine 102 before the end of the prescribed processing period. If, after the receipt of the reading result from the automatic address reader 103 pertaining to the postal code, the control unit 105 determines that the reading result is negative, then another reading request is generated and transmitted to the video encoding system 104. After the receipt of the reading result determined in the video encoding system 104, this reading result is incorporated into the mailing data record. Then the available reading results are returned to the sorting machine 102 in question and the sorting machine 102 sorts the mailpiece associated with the mailpiece image, making use of the received reading results. The reading results are transferred to the sorting machine before the end of the predetermined processing period, regardless of whether it was possible to determine the postal code in the video encoding system 104. If the reading results do not comprise the postal code, it can be provided, for example, that the sorting machine 102 forwards the mailpiece in question to a downstream manual sorting procedure.

As shown in FIG. 1, the mail distribution center 101 is connected to another mail distribution center 108. The connection between the mail distribution centers 101, 108 is preferably established via a wide area network (WAN) such as, for instance, the Internet. The mail distribution center 108 has one or more sorting machines, and one sorting machine 110 is depicted in FIG. 1 by way of example. The sorting machines 110 are especially provided in order to perform outgoing sorting and they are configured in the same manner as the sorting machines 102 of the mail distribution center 101. Moreover, a central control unit 111 is likewise provided in the mail distribution center 108, and it is fundamentally configured in the same manner as the control unit 105 of the mail distribution center 101. In particular, the control unit 111 is connected via a machine interface 109 to each of the sorting machines 110. Optionally, the mail distribution center 108 also has one or more automatic address readers 112, one of which is likewise depicted in FIG. 1 by way of example. The automatic address readers 112 are each connected to the control unit 111 via a reader interface 119.

A video encoding system is not provided in the mail distribution center 108, but the mail distribution center 108 uses video encoding capacities of the mail distribution center 101. If the mail distribution center 108 does not have its own automatic address readers 112, then the automatic address readers 103 of the mail distribution center 101 are also used.

The access of the control unit 105 of the mail distribution center 108 to the reading units 103, 104 of the mail distribution center 101 is made possible by a transmission unit 113. The transmission unit 113 has a reader component 114 associated with the mail distribution center 108, and this reader component 114 is preferably located in the mail distribution center 108. The reader component 114 is connected to the control unit 111 of the mail distribution center 108 via another reader interface 117. The reader interface 117 is configured in the same manner as the reader interfaces 107 for connecting local address readers 112 to the control unit 111. In this manner, the reader component 114 of the transmission unit 108 can be contacted by the control unit 111 in the same manner as a local reading unit 112 of the mail distribution center 108. In particular, the control unit 111 can transfer reading requests to the transmission unit 113 in the same manner as to a local reading unit 112. Moreover, the transmission unit 113 has a machine component 115 associated with the mail distribution center 101. The machine component 115 is registered as a sorting machine in the control unit 105 of the mail distribution center 101 and it is connected to the control unit 105 via another machine interface 116 that is configured in the same manner as the machine interface 106. The registration is carried out under an identifier that allows the identification of the machine component 115. Thus, the machine component 115 of the transmission unit 113 can communicate with the control unit 105 in the same manner as a local sorting machine 102 of the mail distribution center 101. Preferably, the machine component 115 is located in the mail distribution center 101. Data is exchanged between the machine component 115 and the reader component 114 of the transmission unit 113 via the wide area network by means of which the two components 114, 115 are connected to each other.

Encoding rules are stored in the control unit 111 of the mail distribution center 108, and these rules take into account the reader component 114 of the transmission unit 113 as a reading unit. In the control unit 105 of the mail distribution center 101, mailpiece images or mailing data records that are provided by the machine component 115 of the transmission unit 113 are processed according to the encoding rules that are stored there. Here, it can be provided that general encoding rules are used that also apply to local sorting machines 102. By the same token, it can be provided that special encoding rules are provided pertaining to mailpiece images or mailing data records that are provided by the machine component 115 of the transmission unit 113. An explanation will be given below of the determination of mailing data of mailpieces that are to be sorted in the mail distribution center 108, making use of the transmission unit 113 and the corresponding encoding rules.

After a mailpiece image has been acquired in a sorting machine 110 of the mail distribution center 108, in the manner already described in conjunction with the mail distribution center 101, a mailing data record containing the mailpiece image is transmitted from the sorting machine 110 to the control unit 111, or else a mailing data record is generated in the control unit 111. The control unit 111 then generates a reading request according to the encoding rules that are stored in the control unit 111. If the mail distribution center 108 does not have its own automatic address readers 112, then the encoding rules provide that a reading request is transferred to the reader component 114 of the transmission unit 113. The transmission unit 113 receives the reading request via the reader interface 117 and accesses the mailing data record in question via the reader interface 117. In this process, the mailing data record is read in by the reader component 114 and transferred to the machine component 115 of the transmission unit 113. Then the machine component 115 transfers the mailing data record via the machine interface 116 to the control unit 105 of the mail distribution center 101, if the generation of the mailing data record is provided for in the sorting machine 102. In contrast, if the sorting machines 102 transfer mailpiece images and, if applicable, reading results of the primary reader, then the machine component 115 is preferably configured in such a way that it reads out the mailpiece image and the optionally present reading results from the mailing data record and forwards them to the control unit 105 via the machine interface 116. Likewise, the machine component 115 transfers an identification code of the mailpiece image or of the mailing data record to the control unit 105. In one embodiment, this is the identification code that was generated in the sorting machine 110 of the mail distribution center 108 and that is already contained in the mailing data record. Moreover, at the time of the transfer, the identifier of the machine component 115 is indicated under which this component is registered in the control unit 105. If the transfer of the identifier is provided for in the mailing data record, then the identifier contained in the mailing data record and belonging to the sorting machine 110 of the mail distribution center 108 where the mailpiece image was acquired is replaced in the mailing data record with the identifier of the machine component 115.

The control unit 105 preferably handles the received mailing data record or the received mailpiece image according to the prescribed encoding rules in the same manner as s mailing data record that has been received from a local sorting machine 102 via the machine interface 106. This means that, in the present embodiment in which the mail distribution center 108 does not have its own reading unit, preferably no special encoding rules are prescribed for mailing data records or for mailpiece images that are transferred from the machine component 115 of the transmission unit 113 to the control unit 105. Therefore, in the manner described above, first of all, a reading request is transferred to an automatic address reader 103 of the mail distribution center 101 and, if applicable, another reading request is generated for the video encoding system 104, if the postal code of the recipient address could not be determined by the automatic address reader 103 in question. The reading results determined in the contacted reading units 103, 104 of the mail distribution center 101 are each incorporated into the mailing data record.

After the prescribed processing period, the determined reading results are returned via the machine component 116 to the transmission unit 113. This is done in the same manner as the transfer of reading results to a sorting machine 102 that transfers a mailing data record to the control unit 105. In particular, during the transfer, the identifier of the machine component 115 is used in order to identify it. The machine component 115 of the transmission unit 113 then sends the reading results to the reader component 114 of the transmission unit 113. The reader component 114 transfers the reading results via the reader interface 117 to the control unit 111 of the mail distribution center 108. The control unit 111 then incorporates the reading results into the appertaining mailing data record, which is stored in the control unit 111. In this context, the reader component 114 also transfers the identification of the mailing data record on the basis of which the control unit 111 determines the mailing data record. Furthermore, after the reading results have been received, they are transferred to the sorting machine 110 that acquired the mailpiece image, and this is done according to the encoding rules that are stored in the control unit 111. Then the mailpiece in question is sorted in the sorting machine 110 on the basis of the determined reading results.

If the mail distribution center 108 itself has automatic address readers 112, then, after a mailpiece image has been provided by a sorting machine 110, first of all, a reading request is generated for a local automatic address reader 112 and transmitted to the appertaining address reader 112. If the reading result that was returned as the response to the reading request contains the postal code of the recipient address, then the reading result is reported back to the sorting machine 110 that acquired the mailpiece image. If the reading result does not contain the postal code, then the control unit 111 first incorporates the reading result into the mailing data record that was generated for the mailpiece image. A negative reading result is then entered into the mailing data record pertaining to the postal code. The encoding rules that are stored in the control unit 111 provide that a reading request is then transferred to the reader component 114 of the transmission unit 113 pertaining to this mailing data record. On the basis of the receipt of the reading request, the reader component 114 reads in the mailing data record and forwards the mailing data record to the machine component 115.

The machine component 115 then transfers either the mailing data record or the received mailpiece image as well as the contained reading results via the machine interface 116 to the control unit 105 of the mail distribution center 101. If the machine component 115 transfers the mailpiece image and the reading results contained in the mailing data record to the control unit 105, then the control unit 105 generates another mailing data record in which the mailpiece image as well as the reading results are incorporated.

In one embodiment, the control unit 105 handles the mailing data record according to the same encoding rules that also apply to mailing data records and mailpiece images and that are provided by local sorting machines 102. Here, the control unit 105 first determines that the mailing data record contains a negative reading result of an automatic address reader pertaining to the postal code. Then the control unit 105 generates a reading request for the video encoding system 104 according to the encoding rules. After the video encoding system 104 has reported the reading result back to the control unit 105, the control unit 105 stores the reading result in the mailing data record. Then, after the processing period, the reading result is reported back to the machine component 115 of the transmission unit 113 via the applicable machine interface 116. This is done according to the applicable encoding rules in the same manner as the return of reading results to a local sorting machine 102 after the sorting machine 102 has transmitted a mailing data record to the control unit 105. The machine component 115 then forwards the reading results to the reader component 114 of the transmission unit 113. The reader component 114 transfers the reading results to the control unit 111 via the reader interface 117. The control unit 111 subsequently returns the reading result to the sorting machine 110 in which the mailpiece image was acquired. The sorting machine 110 then sorts the mailpiece using the reading results.

In another embodiment, in the control unit 105 of the mail distribution center 101 special encoding rules are stored for mailing data records or mailpiece images that are transferred from the machine component 115 of the transmission unit 113. These encoding rules provide that, on the basis of the receipt of a mailing data record or of a mailpiece image from the machine component 115, a reading request is generated for the video encoding system 104. In this manner, the encoding rules differ from those that apply to mailing data records or mailpiece images and that are provided by local sorting machines 102, since in these cases, the control unit 105 generates reading requests for the automatic address readers 103 of the mail distribution center 101 at first. After the reading result has been received from the video encoding system 104, the reading result is reported back to the machine component 115 of the transmission unit 113 via the appertaining machine interface 116 after the end of the processing period. Subsequently, in the manner already described above, the reading results go to the sorting machine 110 of the mail distribution center 108 where the mailpiece associated with the mailpiece image is being sorted. In this embodiment, there is no need for the machine component 115 to transfer the reading results determined in the mail distribution center 108 to the control unit 105 of the mail distribution center 101.

In the embodiment described above, the mail distribution center 108 has its own automatic address readers 112, but not its own video encoding system. Therefore, the video encoding is carried out entirely in the mail distribution center 101. However, it can likewise be provided that the mail distribution center 108 has its own video encoding system and that the video encoding is only partially shifted to the mail distribution center 101 as the need arises. In this manner, in case of an especially high mail volume in the mail distribution center 108, it is possible to utilize free video encoding capacities of the mail distribution center 101. In order to achieve this, variable encoding rules are stored in the control unit 111 of the mail distribution center 108. As long as the video encoding capacity in the mail distribution center 108 is sufficient to perform the requisite video encoding operations, according to these encoding rules, no reading requests are transferred to the reader component 114 of the transmission unit 113, but only to the local video encoding system. If the number of requisite video encoding operations exceeds the capacity of the local video encoding system, then the encoding rules are changed in such a way that some of the reading requests previously intended for the local video encoding system are transferred to the reader component 114 of the transmission unit 113, so as to utilize the video encoding system 104 of the mail distribution center 101 in the manner described above.

In the manner described above, reading requests can be shifted from one mail distribution center 108 to another mail distribution center 101. In particular, such a shift, as described above, is made possible for automatically reading the recipient addresses and for video encoding. However, the invention is by no means restricted to shifting these reading functions. If reading units are provided for other reading functions, then a mail distribution center can likewise access the corresponding reading units of another mail distribution center via a transmission unit of the type described above. In this context, on the basis of the encoding rules, it can be defined in the control unit of this mail distribution center whether mailing data records or mailpiece images that are provided by the other mail distribution center will be fed exclusively to a reading unit of a certain type or to several reading units that are provided for performing various reading functions.

Likewise, it can be provided for a mail distribution center to carry out reading functions not only for one further mail distribution center but for several further mail distribution centers. For this purpose, each further mail distribution center is connected to the mail distribution center via a transmission unit of the type described above.

Moreover, it can be provided that reading functions for one mail distribution center are carried out by several mail distribution centers. For this purpose, the mail distribution center in question is connected to each of the further mail distribution centers via a transmission unit. These mail distribution centers can each take over various reading functions, and/or certain reading functions can be shifted to various mail distribution centers at different points in time.

In another embodiment, reading functions can be shifted from a mail distribution center to an encoding center instead of a mail distribution center. An encoding center differs from a mail distribution center in that it does not have it own sorting machines, but only has reading units. Consequently, the encoding center is only provided for carrying out reading functions, but not for sorting mailpieces.

Although the invention was described in detail in the drawings and in the presentation above, the presentations are illustrative and are provided by way of example, but are not of a limiting nature; in particular, the invention is not restricted to the described embodiments. The person skilled in the art can glean additional variants of the invention and its execution from the preceding disclosure, from the figures and from the patent claims.

In the patent claims, terms such as “include”, “comprise”, “contain”, “have” and the like do not exclude additional elements or steps. The use of the indefinite article does not preclude a plurality. One individual device can execute the functions of several of the units or devices cited in the patent claims.

The reference numerals indicated in the patent claims are not to be construed as a limitation of the means and steps employed.

1-15. (canceled)

16. A system for determining sorting information for a mailpiece, comprising:
a control unit that is located in a first mail center and that is configured to send reading requests based on received mailpiece images to a reading unit in which the sorting information can be determined, the control unit comprising a first standard interface for feeding mailpiece images; and
a transmission unit that is configured to receive a mailpiece image of the mailpiece in a second mail center and to transfer the mailpiece image to the control unit via the first standard interface, the control unit generating a reading request for the reading unit pertaining to the mailpiece image.

17. The system recited in claim 16, wherein the control unit is configured to output reading results that are determined in the reading unit via the first standard interface, and wherein the transmission unit is configured to receive a reading result pertaining to the mailpiece image via the first standard interface and to transmit the received reading result to the second mail center.

18. The system recited in claim 16, wherein the first standard interface corresponds to a standard interface between the control unit and a sorting machine that comprises an image-acquisition device for acquiring mailpiece images and that is configured to sort mailpieces based on reading results.

19. The system recited in claim 16, wherein the first mail center has at least one sorting machine that communicates with the control unit via another first standard interface.

20. The system recited in claim 16, wherein the first and/or the second mail distribution center has several reading units of different types that consecutively receive reading requests and that determine reading results pertaining to the mailpiece image.

21. The system recited in claim 20, wherein the reading units are located in the first mail center.

22. The system recited in claim 16, wherein the second mail center comprises at least one reading unit of a first type, and the mailpiece image can be transmitted using the transmission unit to the first mail center in order to determine a reading result in a reading unit of a second type if the reading unit of the first type was not able to recognize a given mailpiece feature on the basis of the mailpiece image.

23. The system recited in claim 22, wherein the reading unit of the first type is an automatic address reader for reading a recipient address on the basis of the mailpiece image.

24. The system recited in claim 22, wherein the reading unit of the second type is a video encoding system.

25. The system recited in claim 16, wherein the control unit is configured to generate the reading request as a function of available reading results pertaining to the mailpiece image according to encoding rules, and wherein the transmission unit is configured to transfer in addition to the mailpiece image a reading result that was determined in the second mail center based on the mailpiece image in the reading to the control unit via the first standard interface.

26. The system recited in claim 16, wherein the control unit is configured to generate a reading request for a second reading unit of a different type than the reading unit pertaining to mailpiece images that are transferred by the transmission unit.

27. A system for determining sorting information for a mailpiece, comprising:
a control unit of a second mail center, the control unit being configured to generate a reading request on the basis of a mailpiece image acquired in the second mail center and to supply the mailpiece image to a reading unit via a standard interface; and
a transmission unit that can be connected to the control unit via the standard interface and that is configured to receive the mailpiece image via a second standard interface and to transmit the received mailpiece image to a first mail center.

28. The system recited in claim 27, wherein the control unit is configured to receive reading results via the second standard interface, and wherein the transmission unit is configured to transfer a reading result pertaining to the mailpiece image that was determined in the first mail center to the control unit after transmission to the second mail center via the standard interface.

29. The system recited in claim 27, wherein the control unit is configured to receive the mailpiece image from a sorting machine located in the second mail center and to return the reading result to the sorting machine.

30. The system recited in claim 27, wherein the standard interface corresponds to a standard interface between the control unit and a reading unit.

31. A method for determining sorting information for a mailpiece, comprising:
sending reading requests from a control unit that is located in a first mail center to a reading unit based on received mailpiece images, the control unit comprising a first standard interface for feeding mailpiece images;
determining the sorting information in the reading unit;
receiving a mailpiece image of the mailpiece in a transmission unit in a second mail center;
transferring the mailpiece image to the control unit via the first standard interface; and
generating a reading request for the reading unit, the reading request pertaining to the mailpiece image.
